(19) United States
(12) Patent Application Publication
(10) Pub. No.: US 2009/0198275 A1
(43) Pub. Date: Aug. 6, 2009

(54) Pacifier and pacifier system

(75) Inventors: Douglas E. Godown, Inverness, FL (US); Barry C. Sauls, Crystal River, FL (US)

Correspondence Address: LAW OFFICE OF STEVEN R. OLSEN, PLLC, P.O. BOX 2092, INVERNESS, FL, 34451-2092, US

(73) Assignee: DOUGLAS E. GODOWN, JR.

(21) Appl. No.: 12/012,308

(22) Filed: Jan. 31, 2008

(51) Int. Cl. A61J 17/00

(52) U.S. Cl. 606/236; 606/234

(57) ABSTRACT

The invention relates generally to a pacifier, and more particularly, but without limitation, to a pacifier that is configured to activate one or more output devices based on whether a nipple of the pacifier is located in a baby's mouth. An embodiment of the invention provides a pacifier that includes: a hollow nipple; a sensor located within an interior space of the nipple; and a Light Emitting Diode (LED) located within the interior space of the nipple, the sensor configured to detect whether the nipple is located in a user's mouth, the pacifier configured to illuminate the LED based on the detected location of the nipple with respect to the user's mouth. Embodiments of the invention provide pacifiers that are configured to reward use, entice the baby to reinsert the pacifier when it has been dislodged, and/or alert a caretaker when the pacifier has been dislodged.

### BACKGROUND AND SUMMARY

1. Field of the Invention

The invention relates generally to a pacifier, and more particularly, but without limitation, to a pacifier that is configured to activate one or more output devices based on whether a nipple of the pacifier is located in a baby's mouth.

2. Description of the Related Art

The act of sucking on a nipple can be comforting to an infant or child. Pacifiers configured with artificial nipples are generally known and available for this purpose. Conventional pacifiers have many disadvantages, however. For example, when a conventional pacifier nipple becomes dislodged from a baby's mouth, the baby may experience emotional distress. Furthermore, after a conventional pacifier has been dislodged, a baby with developed motor skills may place a less suitable substitute into its mouth in an effort to sooth itself. Improved pacifiers are therefore needed.

### SUMMARY OF THE INVENTION

Embodiments of the invention provide pacifiers that are configured to reward use, entice the baby to reinsert the pacifier when it has been dislodged, and/or alert a caretaker when the pacifier has been dislodged.

An embodiment of the invention provides a pacifier that includes: a hollow nipple; a sensor located within an interior space of the nipple; and a Light Emitting Diode (LED) located within the interior space of the nipple, the sensor configured to detect whether the nipple is located in a user's mouth, the pacifier configured to illuminate the LED based on the detected location of the nipple with respect to the user's mouth.

Another embodiment of the invention provides a pacifier system. The pacifier system includes: a pacifier, the pacifier including a rechargeable battery and a first inductor coupled to the rechargeable battery; and a docking station configured to couple to the pacifier, the docking station including a second inductor, the docking station and the pacifier configured so that when the pacifier is coupled to the docking station and the second inductor is electrically powered, a first current in the second inductor induces a second current in the in the first inductor and the second current provides charge to the rechargeable battery.

Another embodiment of the invention provides a pacifier that includes: a nipple, the nipple being substantially hollow and translucent; and a flex circuit, a portion of the flex circuit being assembled within an interior space of the nipple, the portion of the flex circuit including a sensor assembled thereto, the sensor being one of a photo sensor and a temperature sensor.

### BRIEF DESCRIPTION OF THE DRAWINGS

The present invention will be more fully understood from the detailed description below and the accompanying drawings, wherein:

FIG. 1 is a functional block diagram of a pacifier assembly, according to an embodiment of the invention;

FIG. 2 is a schematic diagram of a pacifier assembly, according to an embodiment of the invention;

FIG. 3 is a functional block diagram of a pacifier assembly, according to an embodiment of the invention;

FIG. 4 is a schematic diagram of the pacifier assembly illustrated in FIG. 3, according to an embodiment of the invention;

FIG. 5 is a functional block diagram of a pacifier assembly, according to an embodiment of the invention;

FIG. 6 is a functional block diagram of a pacifier assembly, according to an embodiment of the invention;

FIG. 7 is a functional block diagram of a pacifier assembly, according to an embodiment of the invention;

FIG. 8 is a schematic diagram of a synchronized audio/light output device, according to an embodiment of the invention;

FIG. 9 is a schematic diagram of a synchronized audio/light output device, according to an embodiment of the invention;

FIG. 10 is a functional block diagram of a vibration device, according to an embodiment of the invention;

FIG. 11 is a functional block diagram of a pacifier system, according to an embodiment of the invention;

FIG. 12 is a functional block diagram of a pacifier system, according to an embodiment of the invention;

FIG. 13 is a functional block diagram of a pacifier system, according to an embodiment of the invention;

FIG. 14 is a functional block diagram of a pacifier assembly, according to an embodiment of the invention;

FIG. 15 is a cross-sectional elevation view of a pacifier system, according to an embodiment of the invention; and

FIGS. 16A-16G are mechanical views of a pacifier assembly, and portions thereof, according to an embodiment of the invention.

### DETAILED DESCRIPTION

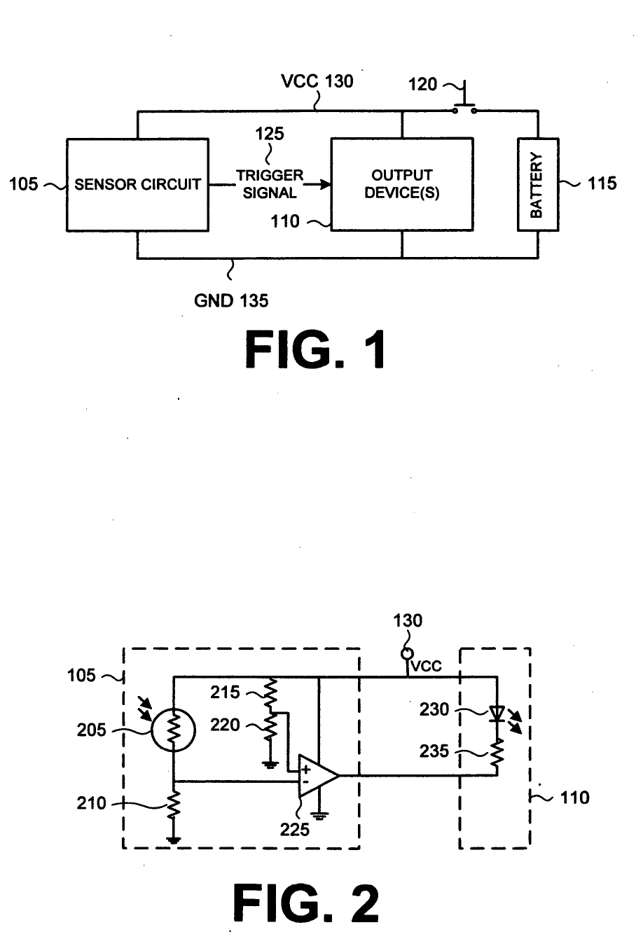

Embodiments of the invention will now be described more fully with reference to FIGS. 1 through 16G, in which embodiments of the invention are shown. This invention may, however, be embodied in many different forms and should not be construed as limited to the embodiments set forth herein. In the drawings, reference designators may be duplicated for the same or similar features.

As used herein, a pacifier or pacifier assembly refers to a collection of components included in a pacifier. A pacifier system includes a pacifier assembly and a docking station that is configured to interface with the pacifier assembly.

FIG. 1 is a functional block diagram of a pacifier assembly, according to an embodiment of the invention. As illustrated in FIG. 1, a sensor circuit 105 is coupled to one or more output devices 110 by a trigger signal 125. A battery 115 supplies a voltage between a (VCC) bus 130 and a ground bus 135. The voltage powers the sensor circuit 105 and the output device(s) 110. An activation switch 120 activates or deactivates the voltage.

The sensor circuit 105 may be or include, for example, a diaphragm switch that is responsive to sucking or a conductive switch that is responsive to contact with saliva or mucous membrane. The sensor circuit 105 may further be or include a photo sensor such as a photosensitive resistor, a phototransistor, or a photodiode that is responsive to light. In alternative embodiments, the sensor circuit 105 may be or include a thermistor that is configured to output the trigger signal at a predetermined threshold temperature. At least portions of the sensor circuit 105 may be located in an interior space of the pacifier nipple, on an external surface of the pacifier nipple, or in communication with same.

The output device(s) 110 may be or include, for example, a Light-Emitting Diode (LED), a blinking LED, a piezoelectric transducer or other audio output device, a Radio Frequency (RF) transmitter, or a vibration device. Multiple output devices 110 may be used in combination. For instance, the output device(s) 110 may include an audio device and at least one LED that have synchronized outputs. In embodiments of the invention, at least one LED is located inside a translucent nipple. In this instance, the nipple may act as a light diffuser.

In embodiments of the invention, the sensor circuit 105 is configured to output the trigger signal 125 and activate the output device(s) 110 when the nipple of a pacifier assembly is not in a baby's mouth. Such embodiments may be appropriate, for instance, when the objective is to entice the baby to reinsert the pacifier, and/or to alert a caretaker that the pacifier has become dislodged from the baby's mouth.

In alternative embodiments of the invention, however, the sensor circuit 105 may be configured to output the trigger signal 125 and activate the output device(s) 110 when the nipple of the pacifier assembly is in the baby's mouth. Such an embodiment may be useful, for example, to reward pacifier use. An example of such an embodiment is when the sensor circuit 105 includes a photosensitive resistor or phototransistor that is configured to activate an audio output device 110 in the absence of light (i.e., consistent with the nipple of the pacifier being located in a baby's mouth).

The battery 115 may be implemented as one or more electrochemical cells in the form of a single battery or multiple batteries, according to design choice. Moreover, the battery 115 may be disposable or rechargeable, according to application needs. For instance, the battery 115 may be or include disposable alkaline cells, or rechargeable Nickel Metal Hydride (NiMH), Nickel Cadmium (NiCd), or Lithium Ion (Li-Ion) cells. In embodiments of the invention described below, one or more rechargeable batteries 115 are used. In such embodiments, NiMH batteries may be a reasonable choice, since they typically have higher capacity than NiCd batteries and lower volatility than Li-Ion batteries. But the invention is not limited to the use of NiMH battery technology.

The embodiments illustrated in FIGS. 24 are exemplary embodiments of the pacifier assembly shown in FIG. 1 and described above.

FIG. 2 is a schematic diagram of a pacifier assembly, according to an embodiment of the invention. As illustrated in FIG. 2, a sensor circuit 105 is coupled to an output device 110. The sensor circuit 105 includes a photosensitive resistor 205, resistors 210, 215, and 220, and a comparator 225. The photosensitive resistor 205 may be, for example, a Cadmium Sulphide (CdS) photocell. FIG. 2 further illustrates an output device 110 that includes a LED 230 coupled in series with a current-limiting resistor 235.

In operation, the photosensitive resistor 205 and the resistor 210 operate as a first voltage divider. The output of the first voltage divider is input to the inverting terminal of the comparator 225. Likewise, the resistors 215 and 220 operate as a second voltage divider to provide a reference voltage to the non-inverting input terminal of the comparator 225. When the output of the first voltage divider exceeds a threshold established by the reference voltage, the comparator 225 outputs a logical low, causing the LED 230 to illuminate.

Variations to the configuration illustrated in FIG. 2 are possible. For instance, in alternative embodiments, the photosensitive resistor 205 may be replaced by a phototransistor or a photodiode. Moreover, in alternative embodiments, the position of the photosensitive resistor 205 and resistor 210 may be switched, depending upon whether light or dark activation of the LED 230 is desired.

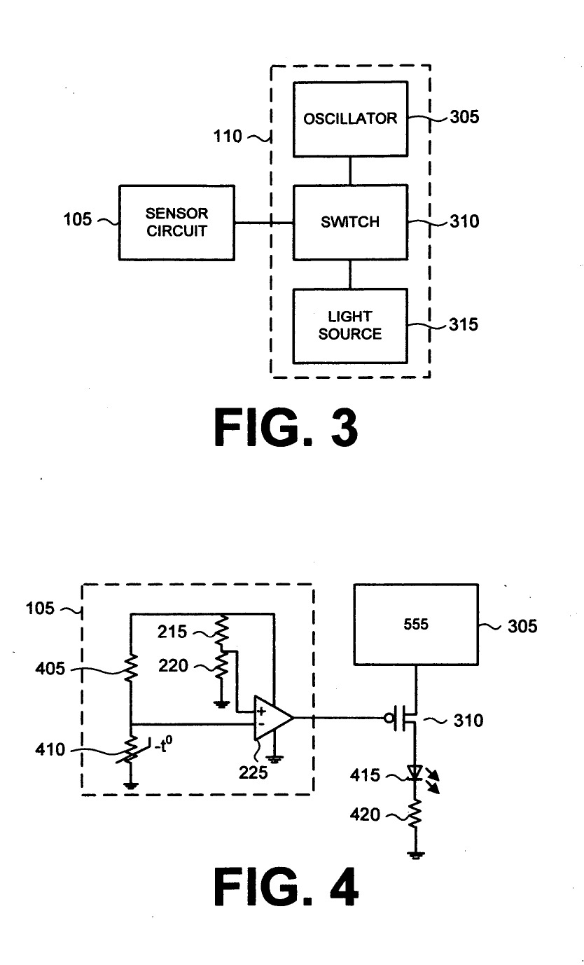

FIG. 3 is a functional block diagram of a pacifier assembly, according to an embodiment of the invention. As illustrated in FIG. 3, a sensor circuit 105 is coupled to an output device 110. The output device 110 includes an oscillator 305 and light source 315 both coupled to a switch 310. In operation, the sensor circuit 105 activates the switch 310, causing a periodic signal (such as a square wave) from the oscillator 305 to be output to the light source 315. Accordingly, the pacifier system illustrated in FIG. 3 generates a blinking light source 315 upon activation of the sensor circuit 105.

FIG. 4 is a schematic diagram of the pacifier system illustrated in FIG. 3, according to an embodiment of the invention. The sensor circuit 105 is coupled to an output device 110. As indicated in FIG. 4, the sensor circuit 105 includes a resistor 405, a thermistor 410, resistors 215 and 220, and a comparator 225. The thermistor 405 may be, for example, a negative temperature coefficient (ntc) thermistor, where the resistance of the thermistor 410 decreases as temperature rises. The resistor 405 and the thermistor 410 create a first voltage divider circuit, with an output of the first voltage divider circuit coupled to the inverting input terminal of the comparator 225. The resistors 215 and 220 operate as a second voltage divider to provide a reference voltage to the non-inverting input terminal of the comparator 225.

FIG. 4 also illustrates that the output device 110 may be implemented using a 555 timer that is configured as an oscillator 305, a transistor as the switch 310, and an LED 415 and series resistor 420 as the light source 315. The switch 310 may be, for example a P-channel Metal Oxide Silicon (PMOS) transistor that is activated by a logic low at the transistor gate.

In operation, the resistance of the thermistor 410 changes with a change in sensed temperature. When the output of the first voltage divider exceeds a threshold voltage determined by second voltage divider, the comparator 225 outputs a logical low to the switch 310. When the switch 310 is closed, a periodic signal (such as a square wave) from the oscillator 305 is passed through the switch 310, causing the LED 415 to illuminate. Accordingly, the pacifier system illustrated in FIG. 4 generates a blinking LED 415 upon activation of the sensor circuit 105.

Variations to the configuration illustrated in FIG. 4 are possible. For instance, instead of a circuit that includes the thermistor 410, the sensor circuit 105 could be or include a diaphragm switch, a conductive switch, or a photo-sensor. In addition, the oscillator 305 could be implemented with crystal oscillator or other oscillator circuit. Furthermore, the switch 310 could be implemented with a voltage-controlled switch other than a PMOS transistor.

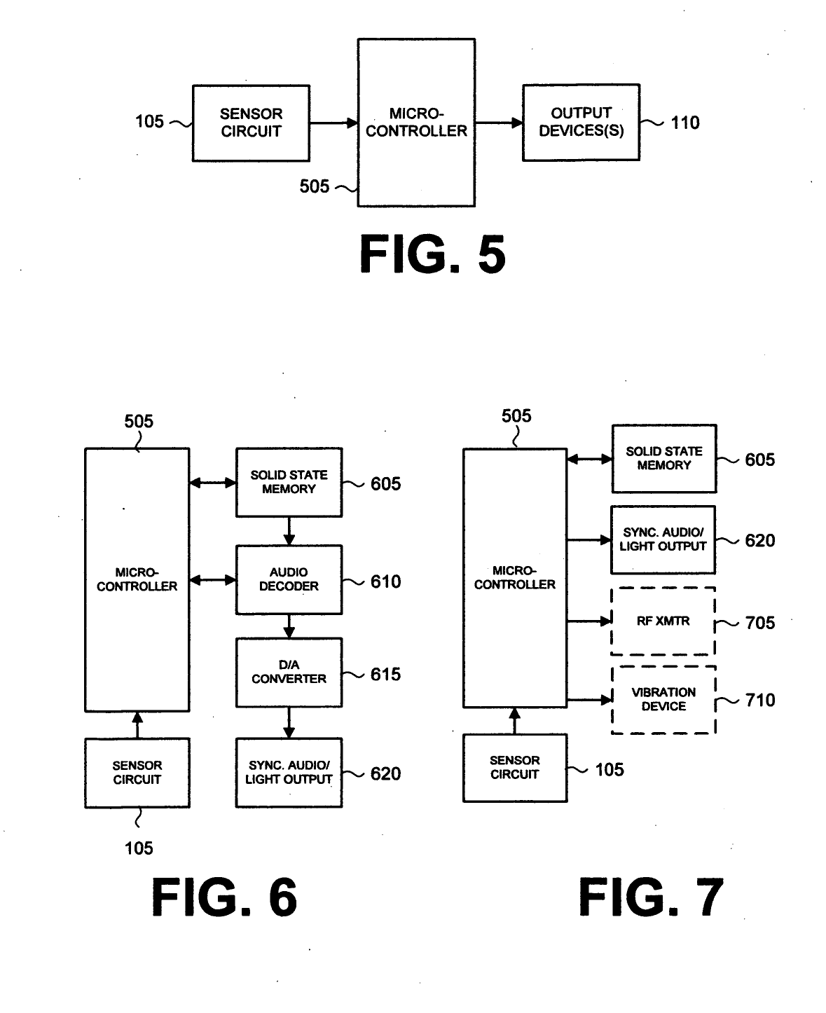

FIG. 5 is a functional block diagram of a pacifier assembly, according to an embodiment of the invention. As illustrated in FIG. 5, a sensor circuit 105 is coupled to an input of a micro-controller 505. Additionally, one or more output devices 110 are coupled to one or more outputs of the micro-controller 505.

The sensor circuit 105 may be or include, for instance, a diaphragm switch, a conductive switch, a photosensitive resistor, a phototransistor, a photodiode, or a thermistor. The sensor circuit 105 may also be or include any of the sensor circuit 105 embodiments described with reference to FIGS. 1-4. The one or more output devices 110 may be or include, for instance, an LED, one or more blinking LEDs, a piezoelectric transducer or other audio device, an RF transmitter, and/or a vibration device. In operation, the sensor circuit 105 outputs a trigger signal to the micro-controller 505. The micro-controller 505 may activate one or more output devices 110 based on the trigger signal. In addition, the micro-controller 505 may perform other functions, as described below.

The embodiments illustrated in FIGS. 6 and 7 are exemplary embodiments of the pacifier assembly described with reference to FIG. 5.

FIG. 6 is a functional block diagram of a pacifier assembly, according to an embodiment of the invention. As illustrated therein, a pacifier assembly includes a micro-controller 505 coupled to a sensor circuit 105. The pacifier assembly further includes a solid state memory 605 and an audio decoder 610 coupled to outputs of the micro-controller 505. In addition, a Digital-to-Analog (D/A) converter 615 is coupled to an output of the audio decoder 610, and a synchronized audio/light output 620 is coupled to an output of the D/A converter 615.

In operation, the solid state memory 605 stores one or more audio files. Audio files are typically stored in a coded (or compressed) format. Under the control of the micro-controller 505, one or more of the coded audio files stored in the solid state memory 605 can be read and decoded by the decoder 610. In turn, the D/A converter 615 can convert the decoded files from digital to analog format, and output an analog audio stream to the synchronized audio/light output device 620. The synchronized audio/light output device 620 produces audio and light output that are synchronized and both based on the analog audio stream that is output from the D/A converter 615.

Variations to the configuration illustrated in FIG. 6 are possible. For instance, in an alternative embodiment, the solid state memory 605 could be packaged together with the micro-controller 505 (e.g., as so-called on-chip memory). Furthermore, in an alternative embodiment, un-encoded audio files could be stored in the solid state memory 605, eliminating the need for the audio decoder 610. In alternative embodiments, the synchronized audio/light output device 620 could be replaced by a standalone audio output device or a standalone light output device (such as one or more LEDs) in accordance with design objectives.

FIG. 7 is a functional block diagram of a pacifier assembly, according to an embodiment of the invention. As illustrated in FIG. 7, the pacifier assembly includes a sensor circuit 105 coupled to an input of a micro-controller 505. The micro-controller 505 is further coupled to a solid state memory 605 and a synchronized audio/light output device 620. The micro-controller 505 may optionally be coupled to an RF transmitter 705 and/or a vibration device 710 (the optional features are indicated by dashed lines in FIG. 7). The RF transmitter 705 may be, for example, a single chip transmitter operating at a low power and a frequency of approximately 27 MHz. The vibration device 710 may be or include, for example, a miniature Direct Current (DC) motor with an unbalanced drive shaft.

In the embodiment illustrated in FIG. 7, the audio decoding and/or D/A converting functions described with reference to FIG. 6 may be performed by the micro-controller 505. Accordingly, the micro-controller 505 is configured to read an audio file from the solid state memory 605 and output an analog signal to the synchronized audio/light output device 620. The RF transmitter 705 may be used to output an alarm signal to a remotely-located receiver (not shown). Separately or together, the RF transmitter 705 and the vibration device 710 may be used to alert a caretaker when the pacifier nipple has become dislodged from a baby's mouth.

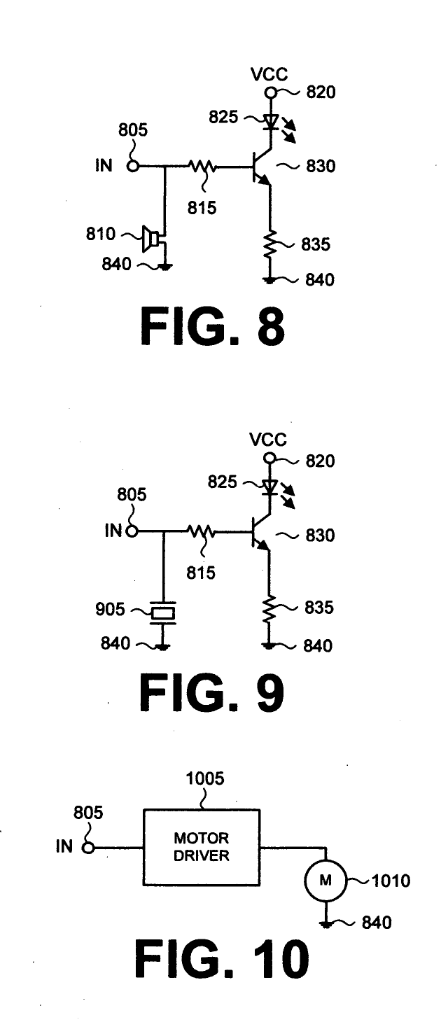

FIGS. 8 and 9 are exemplary embodiments of the synchronized audio/light output device illustrated in FIGS. 6 and 7. Such an output device may optionally be included in any embodiment of the pacifier assembly disclosed herein.

FIG. 8 is a schematic diagram of a synchronized audio/light output device, according to an embodiment of the invention. As illustrated in FIG. 8, a synchronized audio/light output device 620 may include an input terminal 805, a speaker 810, a resistor 815, an LED 825, a transistor 830, and a resistor 835. The resistor 815 and the speaker 810 are coupled to the input terminal 805. The resistor 815 is coupled to a base of the transistor 830. The LED 825 is coupled between a collector of the transistor 830 and a VCC terminal 820. The resistor 835 is coupled between an emitter of the transistor 830 and a ground terminal 840. One terminal of the speaker 810 is also coupled to the ground terminal 840.

In operation, an audio signal, for example from the micro-controller 505, is received at the input terminal 805. The audio signal generates an audio output from the speaker 810 and further modulates current flowing from the collector to the emitter of the transistor 830. Current flow in the transistor 830 causes a modulation of light from the LED 825 that is synchronous with the audio output from the speaker 810.

FIG. 9 is a schematic diagram of a synchronized audio/light output device 620, according to an embodiment of the invention. As illustrated in FIG. 9, the circuit configuration and operation is substantially similar to that described with reference to FIG. 8, except that a piezoelectric transducer 905 replaces the speaker 810.

FIG. 10 illustrates a circuit diagram of a vibration device 710, according to an embodiment of the invention. As illustrated in FIG. 10, the vibration device 710 includes a motor driver 1005 coupled to a vibrating motor 1010. The vibrating motor 1010 may be a DC motor with an unbalanced drive shaft. In operation, an activation signal, for example from the micro-controller 505, is received at the input terminal 805. In response to the activation signal, the motor driver 1005 activates the motor 1010, causing vibration of the pacifier assembly. Such an output device may optionally be included in any embodiment of the pacifier assembly disclosed herein.

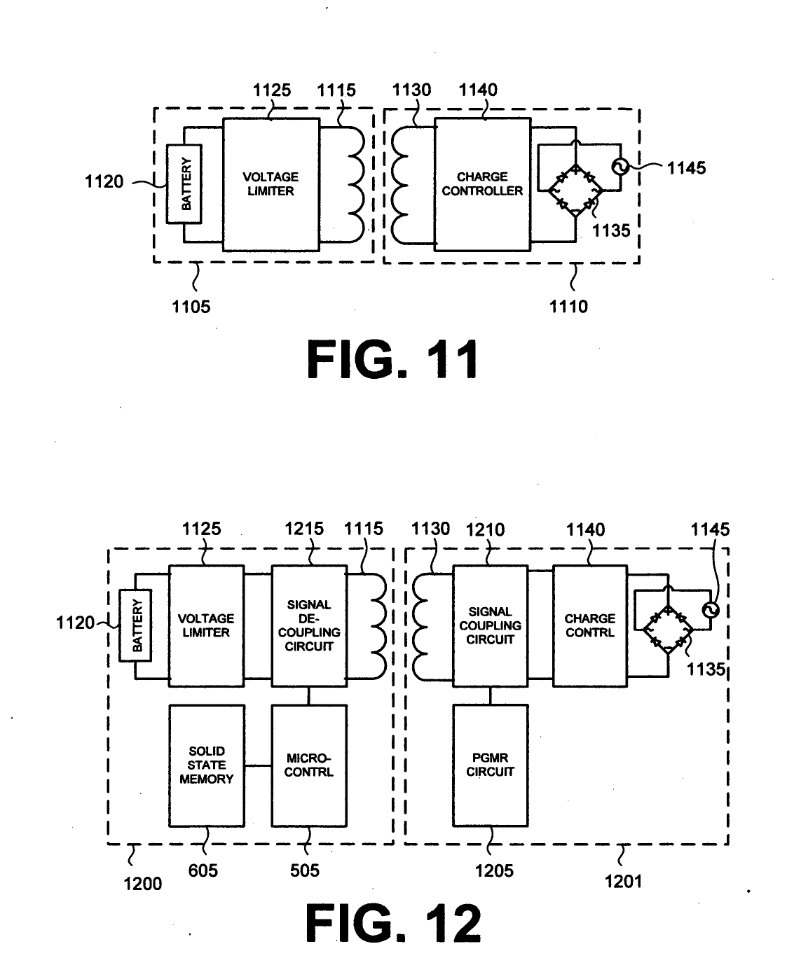

FIGS. 11, 12, and 13 illustrate embodiments of a pacifier system. In each case, the pacifier system includes a pacifier assembly coupled to a docking station.

FIG. 11 is a functional block diagram of a pacifier system, according to an embodiment of the invention. As shown therein, the pacifier system includes a pacifier assembly 1105 inductively coupled to a docking station 1110. The pacifier assembly 1105 includes a battery 1120 and an inductor 1115 coupled to a voltage limiter 1125. The docking station 1110 includes an inductor 1130 and a rectifier 1135 coupled to a charge controller 1140. The rectifier 1135 is coupled to an Alternating Current (AC) voltage source 1145.

In operation, the rectifier 1135 converts an AC voltage from the AC voltage source 1145 into a DC voltage. The charge controller 1140 receives the DC voltage and outputs a controlled voltage to the inductor 1130. The current in the inductor 1130 induces a current in the Inductor 1115 of the pacifier assembly 1105. The induced current in the inductor 1115 may be limited by the voltage limiter 1125 and may further charge the battery 1120. The charge controller 1140 is configured to prevent over-charging of the battery 1120. The voltage limiter 1125 is configured to prevent a voltage spike from damaging the battery 1120.

Variations to the configuration illustrated in FIG. 11 are possible. For instance, in alternative embodiments, the voltage limiter 1125 and/or the charge controller 1140 may not be necessary. In addition, the battery 1120 may be or include multiple batteries, according to design choice.

FIG. 12 is a functional block diagram of a pacifier system, according to an embodiment of the invention. The pacifier system includes a pacifier assembly 1200 coupled to a docking station 1201. Components of the docking station 1201 are substantially similar to the docking station 1110, except that the docking station 1201 further includes a programming circuit 1205 coupled to a signal coupling circuit 1210. The signal coupling circuit 1210 may be coupled, for instance, between the charge control circuit 1140 and the inductor 1130. The signal coupling circuit 1210 may operate, for instance, by rapidly switching the controlled DC voltage output from the charge controller 1140 on and off.

The pacifier assembly 1200 illustrated in FIG. 12 is substantially similar to the pacifier assembly 1105, except that the pacifier assembly 1200 further includes a solid state memory 605 and a signal decoupling circuit 1215 both coupled to a micro-controller 505. The signal decoupling circuit 1215 may be coupled between the inductor 1115 and the voltage limiter 1125.

In operation, the docking station 1201 charges the battery 1120 in the pacifier assembly 1200 as described above with reference to similar components illustrated in FIG. 11. Additionally, the signal coupling circuit 1210 is configured to receive audio data from the programming circuit 1205 and couple the audio data to the controlled voltage received from the charge controller 1140. Accordingly, the current that is output to the inductor 1130, and the corresponding current induced in the inductor 1115, may include a DC voltage component and an audio data component. The signal decoupling circuit 1215 is configured to separate the DC voltage component and the audio data component. The signal decoupling circuit 1215 is further configured to output the DC voltage component to the battery 1120 via the voltage limiter 1125, and output the audio data component to the micro-controller 505. The micro-controller 505 may be configured to store the audio data in the solid state memory 605.

Variations to the system illustrated in FIG. 12 are possible. For instance, in an alternative embodiment, the signal de-coupling circuit 1215 may be omitted.

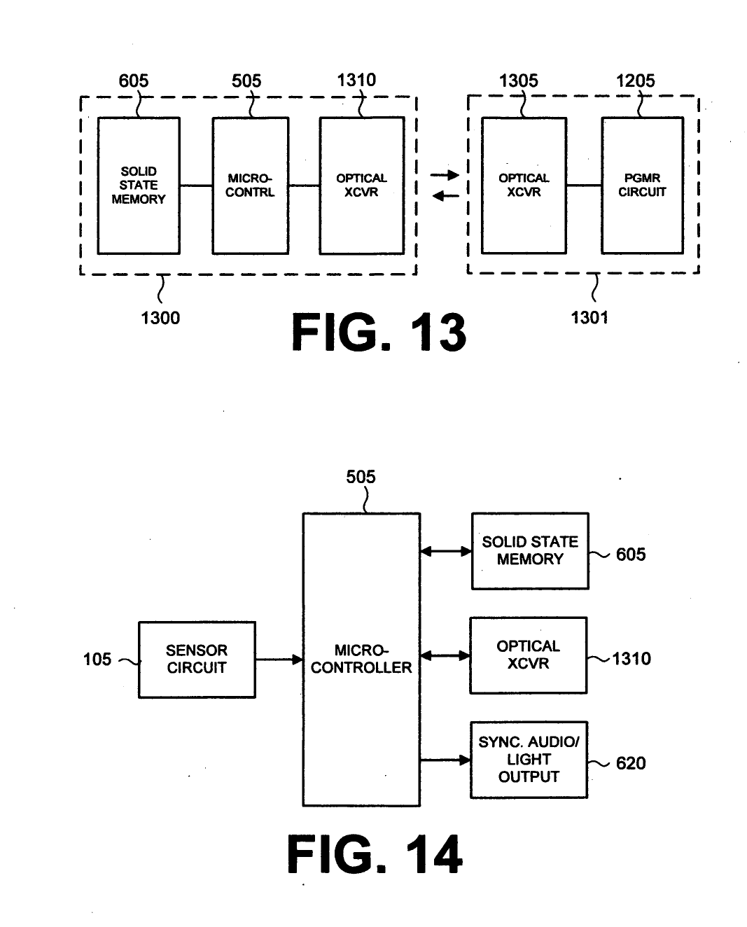

FIG. 13 is a functional block diagram of a pacifier system, according to an embodiment of the invention. As illustrated therein, a pacifier assembly 1300 is configured to communicate with a docking station 1301. The pacifier assembly 1300 may include the features included in the pacifier assembly 1105. In addition, in the embodiment of FIG. 13, the pacifier assembly 1300 further includes a solid state memory 605 and an optical transceiver 1310 both coupled to a micro-controller 505. The docking station 1301 may include the features included in the docking station 1110. In addition, in the embodiment of FIG. 13, the docking station 1301 further includes a programming circuit 1205 coupled to an optical transceiver 1305.

The programming circuit 1205 is configured to output audio data to the optical transceiver 1305. The optical transceiver 1305 is configured to transmit the audio data to the optical transceiver 1310. The optical transceiver 1310 is configured to output the audio data to the micro-controller 505, and the micro-controller 505 is configured to store the audio data in the solid state memory 605. Each of the optical transceivers 1305 and 1310 may include an LED (not shown) that is used as a light emitter when transmitting the audio data and a photodiode when receiving the audio data.

Accordingly, a caretaker or other user can use the pacifier system features illustrated in FIGS. 12 or 13 to store new audio data to pacifier memory for later output. The audio data may be or include, for instance, music, voice, or a combination of music and voice. The pacifier assembly may be configured to output such audio data to an audio output device included in the pacifier assembly (such as a speaker or piezoelectric device) in response to an output from the sensor circuit 105.

FIG. 14 is a functional block diagram of a pacifier assembly, according to an embodiment of the invention. As shown therein, a pacifier assembly includes a sensor circuit 105 coupled to an input of a micro-controller 505. The micro-controller 505 is in communication with a solid state memory 605, an optical transceiver 1310, and a synchronized audio/light output device 620. Accordingly, in an embodiment of the invention, a pacifier assembly is configured to receive audio data via the optical transceiver 1310, store the audio data in the solid state memory 605, and output signals corresponding to the audio data to a synchronized audio/light output device 620.

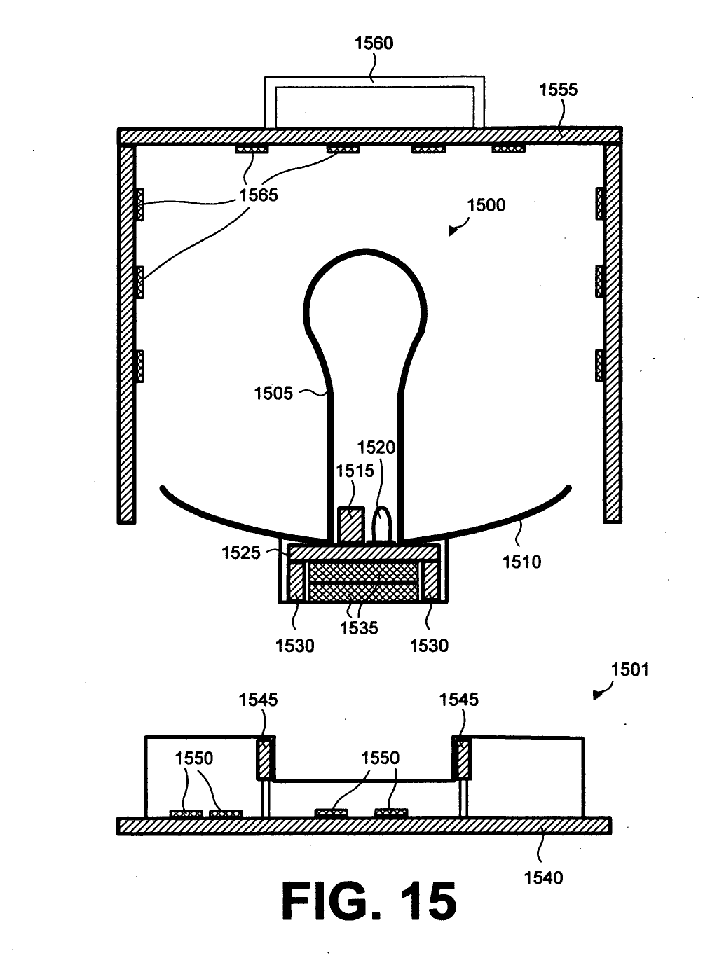

FIG. 15 is a cross-sectional elevation view of a pacifier system, according to an embodiment of the invention. As illustrated in FIG. 15, a pacifier system includes a pacifier assembly 1500 that is configured to interface with a docking station 1501. The pacifier assembly 1500 includes a translucent nipple 1505, a shield 1510, and a circuit card 1525. A photo sensor (such as a photosensitive resistor or a phototransistor) 1515 and an LED 1520 are positioned on a top side of the circuit card 1525 and in an interior space of the nipple 1505. A coil 1530 and batteries 1535 are coupled to a bottom side of the circuit card 1525. Other electrical components (not shown), such as a voltage limiter, signal de-coupling circuit, one or more resistors, a micro-controller, and/or solid state memory may also be mounted to the circuit card 1525.

The docking station 1501 includes a circuit card 1540. Electrical components 1550 (such as a charge controller, signal coupling circuit, and/or programmer circuit) may be mounted on a top surface of the circuit card 1540. In addition, a coil 1545 is mounted on the top surface of the circuit card 1540. The pacifier system illustrated in FIG. 15 further includes a lid 1555. The lid 1555 may include a handle 1560 on an outer surface and Ultra-Violet (UV) LEDs 1565 on an interior surface.

The docking station 1501 is configured to charge the pacifier assembly 1500 by inductive coupling between the coil 1545 and the coil 1530. That same inductive link may be used to transfer audio data from the docking station 1501 to the pacifier assembly 1500 as described with reference to FIG. 12. The Lid 1555 is configured to be placed over the pacifier assembly 1500 when the pacifier assembly 1500 is placed in the docking station 1501. In this position, power may be supplied to the LEDs 1565 from the docking station 1501, and UV light emitted from the UV LEDs 1565 can sterilize an outer surface of the Pacifier 1500.

Variations to the configuration illustrated in FIG. 15 are possible. For instance, the lid 1555 and/or its handle 1560 are optional, according to design choice. In addition, the pacifier assembly 1500 and the docking station 1501 may further include the features included in the pacifier assembly 1300 and the docking station 1301, respectively. Moreover, the pacifier assembly 1500 could include, for instance, a thermistor, a diaphragm switch, a conductive switch, or other sensor circuit instead of the photo sensor 1515 described above. Furthermore, the pacifier assembly 1500 could include, for example, a speaker, a piezoelectric transducer, a RF transmitter, a vibration device, and/or a synchronized audio/light output device instead of, or in addition to, the LED 1520. In other words, the mechanical packaging embodiment illustrated in FIG. 15 can be tailored to accommodate any combination of pacifier assembly and/or pacifier system features disclosed herein.

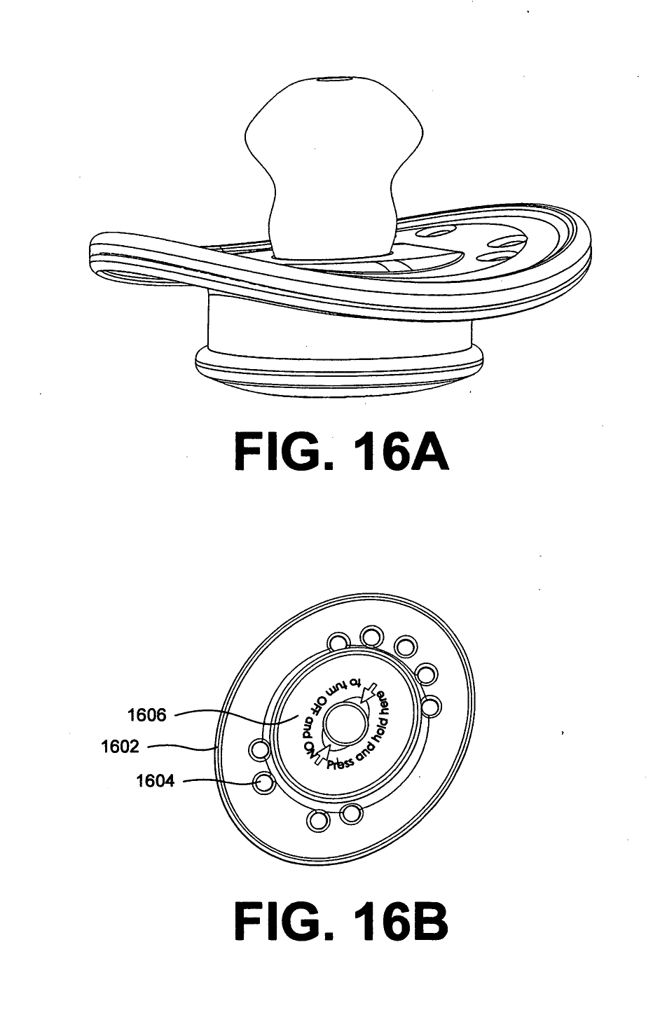

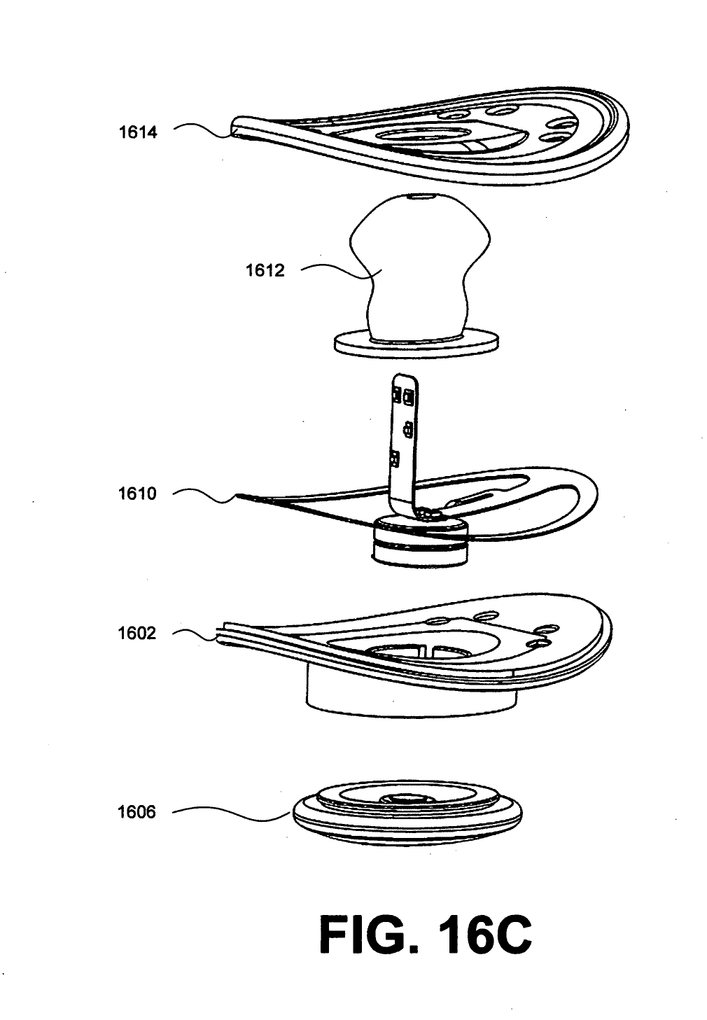

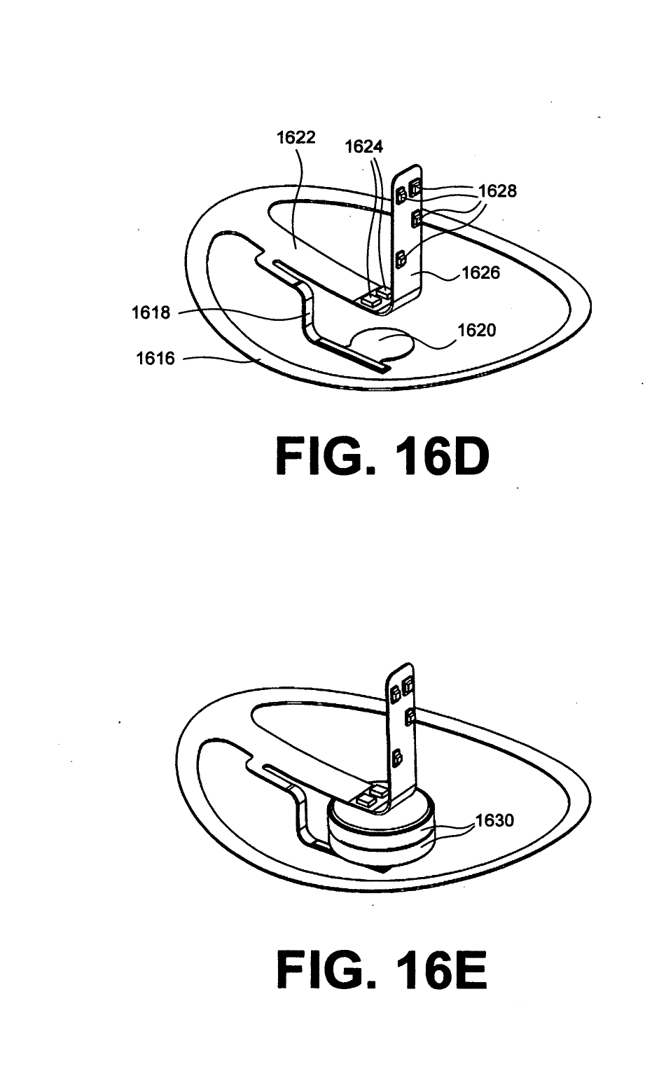

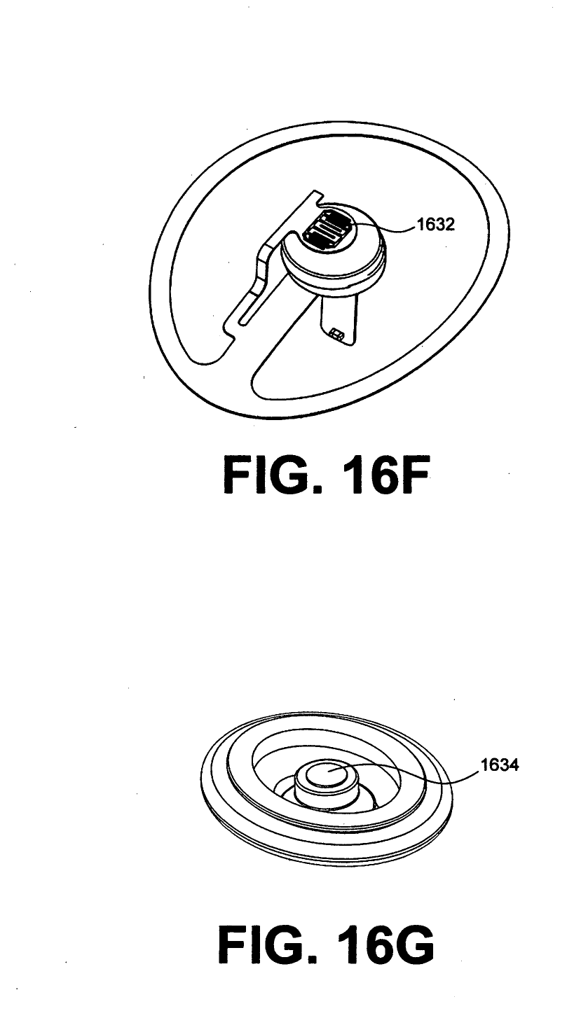

FIGS. 16A-16G are mechanical views of a pacifier assembly, and portions thereof, according to an embodiment of the invention.

FIG. 16A is a perspective view of a pacifier assembly in its final configuration. FIG. 16B is a bottom view of the pacifier assembly, illustrating a lower shield 1602 with multiple ventilation holes 1604. The button 1606 of an activation/deactivation switch is located in the center of the lower shield 1602. The purpose of the activation/deactivation switch is to couple or decouple power to the sensor circuit, micro-controller (if any) and output device(s) that are included in the pacifier assembly.

FIG. 16C is an exploded view of the pacifier assembly. As illustrated, the pacifier assembly includes the button 1606, lower shield 1602, flexible (flex) circuit 1610, a translucent nipple 1612, and an upper shield 1614. The button 1606 is configured to mate with the lower shield 1602, as shown in FIG. 16B. A portion of the nipple 1612 is configured to fit through a center hole in the upper shield 1614. A portion of the flex circuit 1610 is assembled into an interior space of the nipple 1612. During assembly, the lower shield 1602 is affixed to the upper shield 1614, for example by thermal welding, chemical welding, ultrasonic welding, over molding, or the use of an adhesive. Likewise, the button 1606 may be assembled to the lower shield 1602 by thermal welding, chemical welding, ultrasonic welding, over molding, the use of an adhesive, or any other suitable process, according to design choice.

Variations to the configuration illustrated in FIG. 16C are possible. For example, in an alternative embodiment, the nipple 1612 and the upper shield 1614 may be molded or otherwise fabricated as a single piece prior to assembly of the pacifier. Similarly, the button 1606 and the lower shield 1602 may be molded or otherwise fabricated as a single piece prior to final assembly of the pacifier.

FIG. 16D is a perspective view of the flex circuit 1610 without the two disc batteries 1630 and FIG. 16E is a perspective view of the flex circuit 1610 with the batteries 1630. The substrate of the flex circuit 1610 may use, for instance, polyimide as the dielectric material and copper as the signal trace material. The substrate may be fabricated planarly. The flex circuit 1610 substrate includes an outer ring 1616 and inner fingers 1618 and 1622. Atop portion of a pad 1620 at one end of the finger 1618 is configured to make electrical contact with a bottom portion of a battery 1630. A bottom portion of the finger 1622 is configured to make electrical contact with a top portion of a battery 1630. The finger 1622 includes a vertical portion 1626 that is configured to fit into an interior space of the nipple 1612.

Various components may be assembled onto, and electrically coupled to, the substrate of the flex circuit 1610. Components 1624 on a horizontal portion of the inner finger 1622 of the flex circuit 1610 may be or include, for example, a micro-controller, a solid state memory, a voltage limiter, and/or an RF transmitter. Components 1628 mounted to the vertical portion 1626 of the flex circuit 1610 may include, for instance, an LED that is used for light output, an LED that forms a portion of an optical transceiver, a photo sensor (such as a photosensitive resistor or a phototransistor), and/or a temperature sensor (such as a thermistor).

In embodiments of the invention, an inductor (not shown) used for charging the batteries 1630 may be embedded in the outer ring 1616 of the flex circuit 1610. Likewise, in embodiments of the invention that include a RF transmitter, an RF antenna (not shown) can be embedded in the outer ring 1616 of the flex circuit 1610. Moreover, in an embodiment of the invention, copper traces that are embedded in the outer ring 1616 of the flex circuit 1612 may be dual purposed as both a charging inductor and an RF antenna.

Where the pacifier assembly includes a thermistor or other temperature sensor mounted to the vertical portion 1626 located in an interior space of the nipple 1612, the nipple 1612 may be filled with a thermally-conductive liquid, such as mineral oil, to promote heat transfer between an outer surface of the nipple 1612 and the thermistor or other temperature sensor. Additionally, the mineral oil or other thermally-conductive liquid may contain Bitrex™ (denatonium benzoate) or other bitter ingredient so that any leaking of the thermally-conductive liquid from the nipple 1612 would be rapidly detected and unpalatable to a baby or other user of the pacifier assembly.

FIG. 16F is a perspective view of the flex circuit 1610, with batteries 1630, as seen from a bottom side. In particular, battery contacts 1632 on a bottom portion of the pad 1620 are visible. The battery contacts 1632 form a portion of the pacifier activation/deactivation switch. FIG. 16G is a perspective view of the button 1606, as seen from a top side. From this view, button contact 1634 is visible. The pacifier assembly is configured such that when a user depresses the button 1606, the button contact 1634 is electrically coupled to the battery contacts 1632.

The mechanical packaging embodiment illustrated in FIGS. 16A through 16G can be tailored to accommodate any combination of pacifier assembly features disclosed herein. Moreover, a docking station that includes, for instance, a charging inductor, a sterilization lid, and/or an optical transceiver can be configured to interface with a pacifier assembly that includes features described above with reference to FIGS. 16A through 16G.

It will be apparent to those skilled in the art that modifications and variations can be made without deviating from the spirit or scope of the invention. For example, alternative features described herein could be combined in ways not explicitly illustrated or disclosed. Thus, it is intended that the present invention cover any such modifications and variations of this invention provided they come within the scope of the appended claims and their equivalents.

What is claimed is:

1. A pacifier comprising:
a hollow nipple;
a sensor located within an interior space of the nipple; and
a Light Emitting Diode (LED) located within the interior space of the nipple, the sensor configured to detect whether the nipple is located in a user's mouth, the pacifier configured to illuminate the LED based on the detected location of the nipple with respect to the user's mouth.

2. The pacifier of claim 1, wherein the sensor is one of a photosensitive resistor and a phototransistor.

3. The pacifier of claim 2, wherein the pacifier is configured to illuminate the LED when the sensor senses a relatively high-light condition consistent with the nipple being located outside of the user's mouth.

4. The pacifier of claim 1, wherein the sensor is a temperature sensor.

5. The pacifier of claim 1, wherein the pacifier is configured illuminate the LED in a blinking pattern.

6. The pacifier of claim 1, further comprising a vibration device coupled to the sensor, the pacifier configured to activate the vibration device based on the detected location of the nipple with respect to the user's mouth.

7. The pacifier of claim 1, further comprising an audio output device coupled to the photo sensor, the pacifier configured to activate the audio output device based on the detected location of the nipple with respect to the user's mouth.

8. The pacifier of claim 7 wherein the pacifier is configured to illuminate the LED in substantial synchronization with the audio device.

9. The pacifier of claim 7 wherein the pacifier further comprises:
a microcontroller coupled between the sensor and the audio output device; and
a memory device coupled to the microcontroller, the microcontroller configured to decode an audio file in the memory device to produce a decoded digital audio file, the microcontroller further configured to convert the decoded digital audio file to an analog data stream.

10. A pacifier system comprising:
a pacifier, the pacifier including a rechargeable battery and a first inductor coupled to the rechargeable battery; and
a docking station configured to couple to the pacifier, the docking station including a second inductor, the docking station and the pacifier configured so that when the pacifier is coupled to the docking station and the second inductor is electrically powered, a first current in the second inductor induces a second current in the in the first inductor and the second current provides charge to the rechargeable battery.

11. The pacifier system of claim 10, wherein the docking station includes a sterilization device, the docking station and the pacifier configured so that when the pacifier is coupled to the docking station and the sterilization device is electrically powered, the sterilization device sterilizes an outer surface of the pacifier.

12. The pacifier system of claim 11, wherein the sterilization device includes at least one ultra-violet (UV) Light Emitting Diode (LED).

13. The pacifier system of claim 10, further comprising an audio data channel between the pacifier and the docking station, the audio data channel configured to transfer audio data from the docking station to a memory device in the pacifier.

14. The pacifier system of claim 13, wherein the audio data channel includes the first inductor and the second inductor.

15. The pacifier system of claim 13, wherein the audio data channel includes a first optical transceiver in the docking station and a second optical transceiver in the pacifier.

16. A pacifier comprising:
a nipple, the nipple being substantially hollow and translucent; and
a flex circuit, a portion of the flex circuit being assembled within an interior space of the nipple, the portion of the flex circuit including a sensor assembled thereto, the sensor being one of a photo sensor and a temperature sensor.

17. The pacifier of claim 16, further comprising a first light-emitting diode (LED), the first LED being assembled to the portion of the flex circuit, the pacifier configured to illuminate the first LED based on a state of the sensor.

18. The pacifier of claim 16, further comprising a second LED, the second LED being assembled to the portion of the flex circuit, the second LED being a portion of an optical transceiver, the pacifier configured to receive data via the second LED.

19. The pacifier of claim 16, wherein the sensor is the temperature sensor, the pacifier further comprising a thermally-conductive fluid within the interior space of the nipple, the thermally-conductive fluid aiding thermal transfer from an outer surface of the nipple to the temperature sensor.

20. The pacifier of claim 16, further comprising:
an inductor embedded in the flex circuit; and
a battery coupled to the flex circuit, the pacifier configured to charge the battery based on a current induced in the inductor.
